(19) United States
(12) Patent Application Publication
(10) Pub. No.: US 2017/0157996 A1
(43) Pub. Date: Jun. 8, 2017

(54) TYRE COMPRISING A FOAM MATERIAL FOR SOUND ABSORPTION

(71) Applicant: BRIDGESTONE CORPORATION, Tokyo (JP)

(72) Inventors: Barbara Maria SECCHI, Rome (IT); Pasquale AGORETTI, Ariccia (IT); Michele AMURRI, Rome (IT); John HOUSE, Rome (IT)

(73) Assignee: BRIDGESTONE CORPORATION, Tokyo (JP)

(21) Appl. No.: 15/327,233

(22) PCT Filed: Jul. 21, 2015
(86) PCT No.: PCT/IB2015/055525

§ 371 Date: Jan. 18, 2017

(30) Foreign Application Priority Data
Jul. 21, 2014 (IT) RM2014A000404

(51) Int. Cl. B60C 19/00; C08J 9/00; C08G 65/40; B60C 5/00; B60C 1/00

(52) U.S. Cl. CPC B60C 19/002; B60C 5/002; B60C 1/0008; C08G 65/40; C08J 9/00; C08G 2101/005

(57) ABSTRACT

A tyre comprising a layer suitable to ensure the sealing under pressure of the air contained in the inner cavity of the carcass and a foam material for sound absorption based on a polycondensate of polyphenolic compounds of natural or synthetic origins housed inside said inner cavity. Preferably, the foam material is based on flavonoid tannins.

### TECHNICAL FIELD

The present invention relates to a tyre comprising a foam material for sound absorption. More precisely, the present invention relates to a tyre comprising a foam material housed in the inner cavity covered by a layer impermeable to air and filled with air under pressure.

### BACKGROUND ART

One of the noises produced by a tyre in service regards the resonance cavity sound generated by vibration of the air under pressure inside the inner cavity of the tyre. To reduce this type of noise, the use of a porous material applied to the surface of the impermeable layer of the tyre's inner cavity in a manner such that the resonance cavity sound is absorbed by the porous material has long been known.

The porous material most commonly used for this purpose is polyurethane. However, despite having satisfactory properties in terms of sound absorption, polyurethane-based foam materials suffer from the drawback of being easily inflammable.

The need was thus felt to replace the polyurethane-based foam material with another foam material that, even though having the same performance in terms of sound absorption, did not suffer from the above-mentioned drawback.

The applicant has surprisingly found that the polyurethane-based foam material can be replaced with a foam material based on polyphenolic polycondensates of natural or synthetic origin, which has proved to be just as efficient in terms of sound absorption, but without having the above-mentioned inherent drawback of polyurethane-based materials.

### DISCLOSURE OF INVENTION

The subject of the present invention is a tyre comprising an impermeable layer suitable to ensure the sealing under pressure of the air contained in the inner cavity of the carcass and a foam material housed inside said inner cavity; said tyre being characterized in that said foam material is based on a polycondensate of polyphenolic compounds.

Preferably, said foam material is based on flavonoid tannins.

Preferably, said foam material is prepared starting from flavonoid tannins, furfuryl alcohol, a foaming agent and a catalyst.

Preferably, said foam material is totally formaldehyde-free.

The absence of formaldehyde ensures that the foam material has advantages related to the reduced usage of noxious substances and greater flexibility.

Preferably, said foam material has a density ranging from 0.01 to 0.25 g/cm³.

Preferably, the foam material occupies a volume ranging from 0.1% to 100% of the volume of the inner cavity. More preferably, the foam material has a thickness ranging from 10 mm to 200 mm and a width ranging from 10% to 100% of the width of the inner cavity.

Preferably, the foam material occupies a volume ranging from 0.4% to 20% of the volume of the inner cavity. More preferably, the foam material has a thickness ranging from 20 mm to 30 mm and a width ranging from 20% to 40% of the width of the inner cavity.

Preferably, said foam material is housed on an inner surface of the impermeable layer of the inner cavity of the tyre.

Preferably, the foam material can be housed in the cavity in the form of a toroid, or in the form of a strip with a length equal to that of the impermeable layer, or in the form of single segments assembled so as to cover the entire length of the impermeable layer.

### BEST MODE FOR CARRYING OUT THE INVENTION

An embodiment is described below by way of non-limitative example.

The applicant has performed a comparison in terms of sound absorption and inflammability between a polyurethane-based foam material normally used in tyres and a foam material based on flavonoid tannins according to the present invention.

The polyurethane-based foam material is marketed under the brand name Metzonor 023 and is produced by Metzler Schaum GMBH.

The foam material based on flavonoid tannins according to the present invention is produced by a synthesis reaction in which formaldehyde is not used, and has an apparent density of 0.028 g/cm³ and an average cell diameter of 250 micron.

The sound absorption test was performed according to the ISO 10534-2 Standard at a frequency ranging from 200 to 2000 Hz; the inflammability test was carried out by bringing the material in contact with a flame at a temperature of approximately 500° C. and calculating the contact time necessary for combustion of the material to become self-sustaining.

From the sound absorption tests, it was observed that the performance of the two foam materials is the same in terms of sound absorption.

From the inflammability tests, it was observed that while the polyurethane-based foam material needs only two seconds in contact with the flame to continue with self-sustaining combustion, the foam material according to the present invention does not exhibit self-sustaining combustion phenomena even if contact with the flame is maintained for a prolonged time.

The aging tests were carried out in an oven for three days at 70° C., after which the sound absorption tests were performed. The results are indicated in terms of percentage variation with respect to the sound absorption coefficient of non-aged samples. The foams forming the subject of the present invention show the same absorption coefficient before and after aging, while the reference foams show a drop of 10% in the coefficient after aging.

It has been observed that if made in the absence of formaldehyde, the foam material has greater flexibility for the same power of absorption. Therefore, the absence of formaldehyde not only entails safety advantages, as formaldehyde is a toxic compound, but also ensures more efficient utilization of the foam material according to the present invention. As will be immediately evident to a person skilled in the field, the more the foam material is flexible, the more its positioning inside the inner cavity of the carcass will be secure and effective. In fact, the greater flexibility of the foam material can ensure that breakage does not occur during its manipulation as well as its more effective placement inside the inner cavity of the carcass.

To summarize, as well as ensuring performance in terms of sound absorption comparable to that of polyurethane-based foam material, the foam material used in tyres according to the present invention has the advantages of having high flame resistance, a high level of infusibility and greater aging resistance.

Furthermore, for a more complete assessment of the advantages of the present invention, it should be considered that the foam material use in tyres according to the present invention can be obtained from raw materials of natural origin and without the use of formaldehyde (classified as a type 2 carcinogenic with type 3 acute toxicity). Once again, it should be underlined how the absence of formaldehyde, in addition to ensuring advantages in terms of safety, also ensures greater flexibility of the related foam material with the associated advantages indicated above.

1. A tyre comprising an impermeable layer suitable to ensure the sealing under pressure of the air contained in the inner cavity of the carcass and a foam material housed inside said inner cavity; said tyre being characterized in that said foam material is based on a polycondensate of polyphenolic compounds.

2. A tyre according to claim 1, characterized in that said foam material is based on flavonoid tannins.

3. A tyre according to claim 2, characterized in that said foam material is prepared starting from flavonoid tannins, furfuryl alcohol, a foaming agent and a catalyst.

4. A tyre according to claim 1, characterized in that said foam material is formaldehyde-free.

5. A tyre according to claim 1, characterized in that said foam material has a density ranging from 0.01 g/cm³ to 0.25 g/cm³.

6. A tyre according to claim 1, characterized in that said foam material occupies a volume ranging from 0.1% to 100% of the volume of the inner cavity.

7. A tyre according to claim 6, characterized in that said foam material has a thickness ranging from 10 mm to 200 mm and a width ranging from 10% to 100% of the width of the inner cavity.

8. A tyre according to claim 1, characterized in that said foam material occupies a volume ranging from 0.4% to 20% of the volume of the inner cavity.

9. A tyre according to claim 8, characterized in that said foam material has a thickness ranging from 20 mm to 30 mm and a width ranging from 20% to 40% of the width of the inner cavity.

10. A tyre according to claim 1, characterized in that said foam material is housed on a surface of the impermeable layer of the inner cavity of said tyre.

11. A tyre according to claim 1 characterized in that said foam material is housed in the cavity in the form of a toroid, or in the form of a strip with a length equal to that of the impermeable layer, or in the form of single segments assembled so as to cover the entire length of the impermeable layer.
